(19) United States
(12) Patent Application Publication
(10) Pub. No.: US 2013/0212478 A1
(43) Pub. Date: Aug. 15, 2013

(54) AUDIO NAVIGATION OF AN ELECTRONIC INTERFACE

(71) Applicant: TVG, LLC, (US)

(72) Inventor: Ted Douglas Karr, Sherwood, OR (US)

(73) Assignee: TVG, LLC, Beaverton, OR (US)

(21) Appl. No.: 13/651,042

(22) Filed: Oct. 12, 2012

Related U.S. Application Data
(60) Provisional application No. 61/599,344, filed on Feb. 15, 2012.

(51) Int. Cl. G06F 3/16

(52) U.S. Cl. CPC G06F 3/167
USPC 715/727

(57) ABSTRACT

Embodiments of methods, apparatuses, devices and/or systems for navigating electronic interfaces via an audio signal comprising commands are disclosed.

### FIELD

The field of claimed subject matter relates to the navigation of electronic interfaces on electronic devices wherein navigation is based at least in part on reception of audio signals, derivatives or representations thereof.

### BACKGROUND

Technological advances in computing devices have increased functionality however, absent explicit programming, electronic interfaces, such as web browsers, are still manipulated through a physical user interface employing mice, buttons, touch screens, or other interfaces.

### BRIEF DESCRIPTION OF THE DRAWINGS

FIG. 1 discloses one embodiment of a computing device for navigating electronic interfaces, such as for an electronic device.

receiving audio signals and transmitting corresponding commands to a back-end server for processing via a communication network.

FIG. 2 is a block diagram showing components of one embodiment of a computing device for navigating electronic interfaces.

FIG. 3 is a schematic diagram demonstrating a display screen feature of one embodiment.

FIG. 4 is a schematic diagram showing a detailed view of a symbol corresponding to a particular display feature of an embodiment.

FIG. 5 is a flow diagram illustrating an embodiment of a method of directing audio commands to a symbol corresponding to a particular display feature.

FIG. 6 is a schematic diagram illustrating an embodiment of a mobile station.

FIG. 7 is a schematic diagram showing a detailed view of an embodiment.

### DETAILED DESCRIPTION

In the following detailed description, numerous specific details are set forth to provide a thorough understanding of claimed subject matter. However, it will be understood by those skilled in the art that claimed subject matter may be practiced without specific details. In other instances, methods, apparatuses or systems that would be known by one of ordinary skill have not been described in detail so as not to obscure claimed subject matter.

Reference throughout this specification to one implementation, an implementation, one embodiment, an embodiment, or the like may mean that a particular feature, structure, or characteristic described in connection with a particular implementation or embodiment may be included in at least one implementation or embodiment of claimed subject matter. Thus, appearances of such phrases in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, the particular context of the description or usage of these terms may provide helpful guidance regarding inferences to be drawn for that particular context.

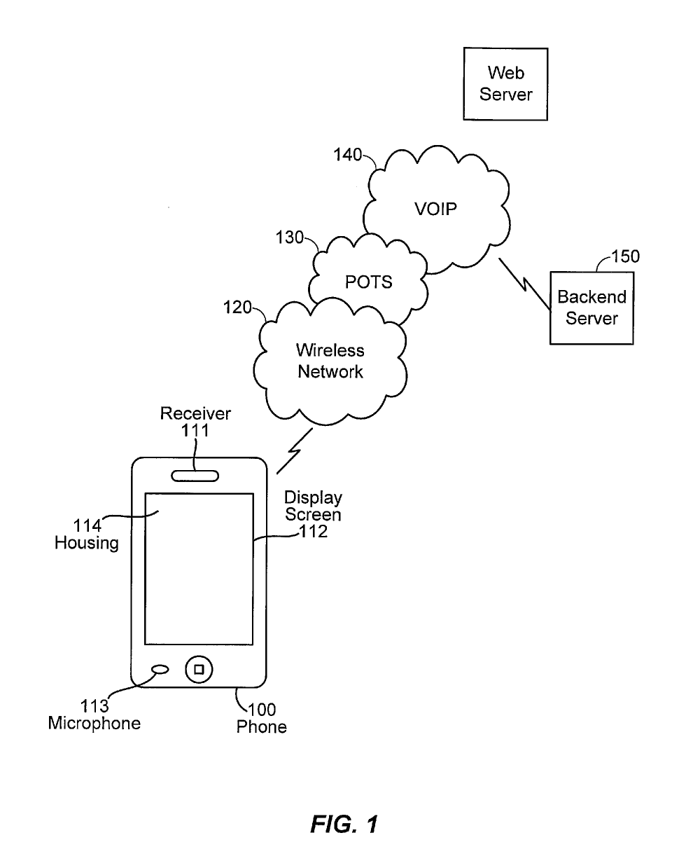

FIG. 1 is a diagram illustrating an embodiment wherein a computing device 100 may issue commands to a back-end server 150 via a communication network including, but not limited to a wireless network 120, a wired network 130, or a VoIP network 140.

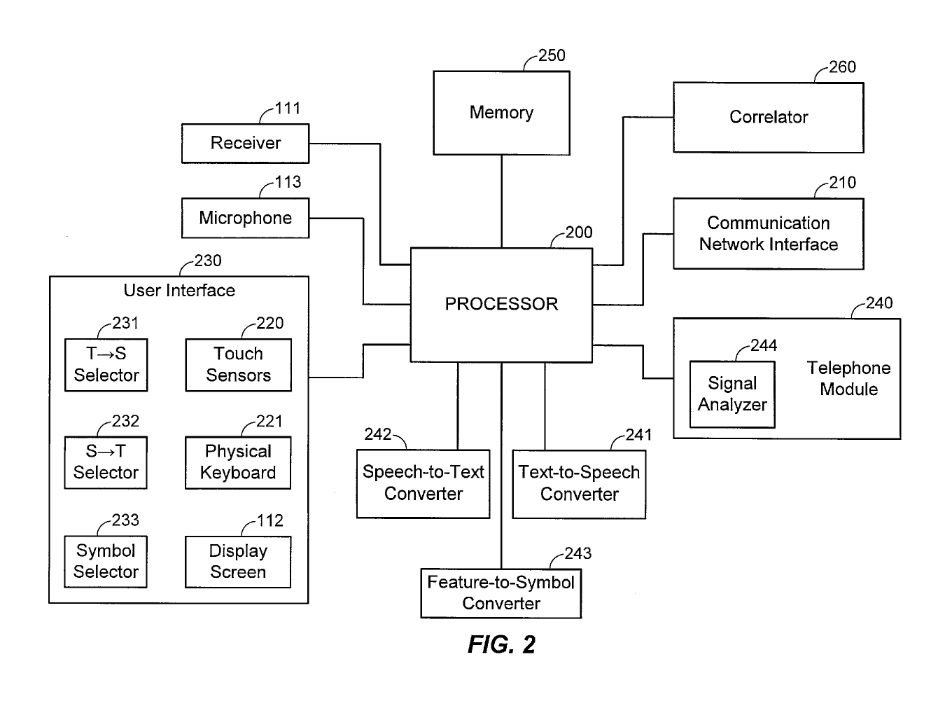

Computing device may include a microphone 113, a processor 200 (Referring to FIG. 2) or a communication network interface 210. Processor 200 may be coupled to microphone 113 to detect audio signals received by microphone 113. A communication network interface 210 may transmit electronic audio signals to back-end server 150 using an electronic audio connection that may be established between computing device and back-end server. Audio signal may convey a command which may perform an operation that may be generated internally by computing device.

In an embodiment shown in FIG. 1, a computing device is shown as a phone. Although computing device 100 is shown and described, it is understood that computing device 100 may be any communication devices mentioned in this disclosure. An exterior of computing device 100 may be made of a housing 114 within which may include several integrated components including, but not limited to, a display screen 112, a receiver 111 such as an ear-piece speaker for generating audio signals, or one or more audio signal receiving components, such as microphone 113. Although one microphone, 113, is shown and described, it is understood that computing device 100 may include multiple audio receiving components. Therefore, the term “microphone” 113 is understood to represent one or more audio receiving components. Computing device 100 may also implement noise suppression, acoustic echo cancellation (AEC), or other audio enhancement techniques to improve sound quality.

An audio signal received by microphone 113 may be processed by computing device 100 to perform operations on computing device 100 or back-end server 150. For example, computing device 100 may process an audio signal comprising commands and/or perform one or more operations or transmit an electronic audio signal to a back-end server where electronic audio signal may be processed. Computing device 100 could provide an option to switch to text input mode. Alternatively, computing device 100 may automatically switch input mode from speech to text. In one embodiment, computing device 100 may mute microphone 113 or any other audio signal sensing device or computing device 100 on or after switching to text input mode. In one embodiment, muting microphone 113 results in audio signals sensed by microphone 113 not be transmitted to back-end server 150. Muted microphone 113 may continue to sense audio signals in a surrounding environment.

Computing device 100 may, in an embodiment, however transmit an electronic audio signal to backend server 150. For example, an electronic audio signal could be transmitted to backend server 150 via a communication network such as, but not limited to, wireless network 120, wired network 130, or VoIP network 140.

FIG. 2 is a block diagram illustrating an embodiment of computing device 100. Computing device 100 may include a communication network interface 210 for receiving and/or transmitting communication signals, such as, but not limited to, audio signals, electronic audio signals, video signals, or other relevant signals. Computing device 100 also may include receiver 111 for generating audio signals in response to incoming radio frequency or other signals or microphone 113 for sensing audio signals. Computing device 100 may also include a user interface 230. User interface 230 may include a display screen 112 or touch sensors 220 for sensing touch and/or motion. Computing device 100 may include a physical keyboard 221 for receiving keystroke input, or a virtual keyboard displayed by display screen 112 for accepting input signals via touch sensors 220. Touch sensors 220 may be based at least in part on resistive sensing, capacitive sensing, optical sensing, force sensing, surface acoustic wave sensing, and/or other sensing techniques or combinations of sensing techniques. Coordinates of touch sensors 220 that respond to touch or motion may represent signals. Touch sensors 220 may be embedded in display screen 112, or may be embedded in a touch-sensing panel separate from display screen 112. In other embodiments, computing device 100 may include other types of sensors for accepting input signals other than touch input signals including, but not limited to, a motion sensor, such as an accelerometer. For example, input signals may be provided by shaking computing device 100 or moving computing device in a particular manner.

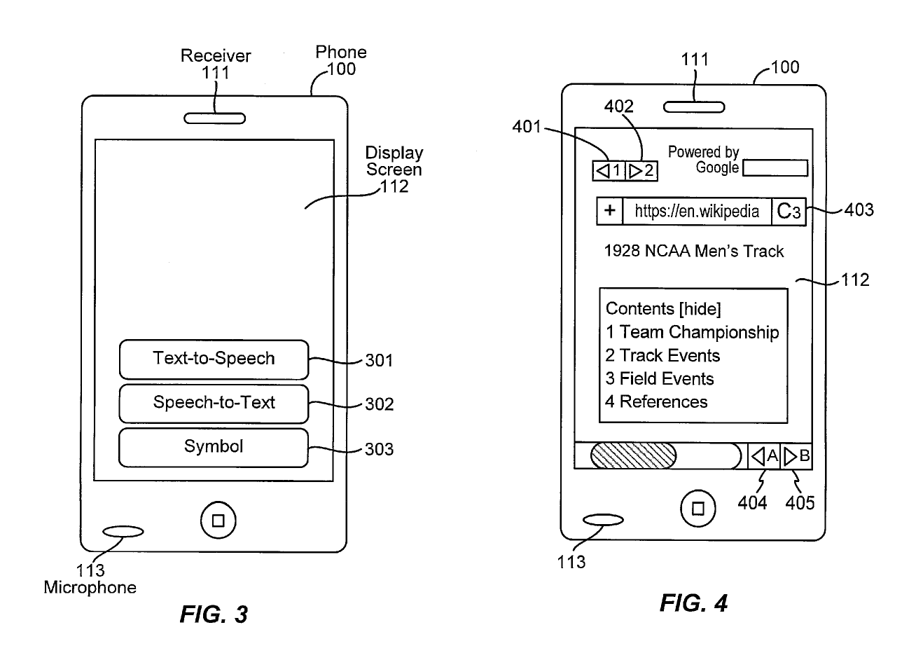

In one embodiment, user input interface 230 may comprise one or more buttons for invoking a text-to-speech feature 231. Text-to-speech selector 231 may comprise a physical button or a virtual button 301 (FIG. 3). Physical button may comprise a dedicated “text-to-speech” button, or one or more buttons identified by text shown on display screen 112. In an embodiment where text-to-speech selector 231 comprises a virtual button, virtual button 301 may be embedded in display screen 112 which may include touch sensors 220. Display screen 112 may show a graphical “text-to-speech” virtual button that may be pressed to invoke text-to-speech conversion. In an alternative embodiment, text-to-speech selector 231 may comprise a virtual button implemented on a touch-sensing panel separate from display screen 112. Touch-sensing panel may direct a cursor on display screen 112 to select graphical “text-to-speech” buttons shown on display screen 112. In alternative embodiments, text-to-speech conversion may be activated by a combination of one or more physical buttons and/or virtual buttons. If text-to-speech selector 231 is activated, text-to-speech converter 241 of a near-end computing device 100 may be activated. Text-to-speech converter 241 may be used to convert near-end input signals into audio signals for transmission to back-end server 150. Text-to-speech converter 241 may be used to process near-end audio signals comprising commands into operations to be performed on computing device 100.

Text-to-speech converter 242 may convert text input signals into audio signals based at least in part on one or more speech synthesis techniques. Synthesized speech may be created by concatenating pieces of electrical audio signals stored in memory 250. Text-to-speech converter 241 may be activated and/or deactivated by user interface 230.

In one embodiment, user input interface 230 may also include one or more buttons for invoking speech-to-text conversion 232. A speech-to-text selector 232 could be implemented by physical or virtual button mechanisms, similar to the implementation of text-to-speech selector 231. If speech-to-text 232 is selected, a speech-to-text converter 242 of computing device 100 may be activated. Speech-to-text converter 242 may be used to convert audio signals into text for displaying on display screen 112. Speech-to-text selector 232 may comprise a physical button or a virtual button 302 (FIG. 3). Physical button may comprise a dedicated “speech-to-text” button, or one or more buttons identified by text shown on display screen 112. In an embodiment where speech-to-text selector 232 is a virtual button, virtual button 302 (FIG. 3) may be embedded in a display screen 112 that may include touch sensors 220. Display screen 112 may show a graphical “speech-to-text” virtual button that may invoke speech-to-text conversion. In an alternative embodiment, speech-to-text selector 232 may be a virtual button implemented on a touch-sensing panel separate from display screen 112. Touch-sensing panel may be used to direct a cursor on display screen 112 to select a graphical “speech-to-text” button shown on a display screen 112. In alternative embodiments, speech-to-text conversion may be activated by a combination of one or more physical buttons and/or virtual buttons. If speech-to-text 232 is selected, speech-to-text converter 242 of near-end computing device 100 may be activated. Speech-to-text converter 242 may be used to convert audio signals into text for transmission to a back-end server 150. Speech-to-text converter 242 may be used to convert audio signals into text for operations that may be performed on computing device 100.

Speech-to-text converter 242 identifies words in an audio signal based at least in part on one or more speech recognition techniques, and may cause display screen 112 to display recognized words in text. Speech-to-text converter 242 may be activated and deactivated by input to the user interface 230.

In one embodiment, user input interface 230 may also include one or more buttons (symbol selectors) for invoking feature-to-symbol conversion/assignment 233. Symbol selector 233 may be implemented by physical or virtual button mechanisms, similar to implementation of text-to-speech selector 231. If symbol selector 233 is selected, a feature-to-symbol converter 243 of the computing device 100 may be activated. Feature-to-symbol converter 243 may convert an electronic interface's features into user-definable symbols for displaying on display screen 112. Symbol selector 233 may comprise a physical button or virtual button 303 (FIG. 3). Physical button may comprise a dedicated “symbol” button, or one or more buttons identified by text shown on display screen 112. In an embodiment where symbol selector 233 comprises a virtual button, virtual button 303 (FIG. 3) may be embedded in display screen 112 that may include touch sensors 220. Display screen 112 may show a graphical “symbol” virtual button that may be pressed to invoke feature-to-symbol conversion. In an alternative embodiment, symbol selector 233 may comprise a virtual button implemented on a touch-sensing panel separate from display screen 112. Touch-sensing panel may direct a cursor on display screen 112 to select a graphical “symbol” button shown on display screen 112. In alternative embodiments, feature-to-symbol conversion may be activated by a combination of one or more physical buttons or virtual buttons. If symbol selector 233 is selected, feature-to-symbol converter 243 of computing device 100 may be activated. Feature-to-symbol converter 243 may be used to convert an electronic interface's features into user-definable symbols for transmission to back-end server 150. Feature-to-symbol converter 243 may be used to convert an electronic interface's features into user-definable symbols for operations which may be performed on computing device 100. Feature-to-symbol converter 243 may identify words associated with symbols in an audio signal based at least in part on one or more speech recognition techniques, and may cause display screen 112 to show recognized symbols in electronic interface. Feature-to-symbol converter 243 may be activated and/or deactivated by input to user interface 230.

In another embodiment, computing device 100 also may include a telephone module 240 which may be responsible for coordinating various tasks involved in a telephone call. Although one processor 200 is shown, it is understood that any number of processors or data processing elements may be included in computing device 100. Telephone module 240 may coordinate tasks such as receiving an incoming call signal, sending an outgoing call signal, activating speech-to-text conversion, activating text-to-speech conversion, activating feature-to-symbol conversion or directing a call to voice mail system.

FIG. 3 illustrates an embodiment based at least in part on a hand-held computing device's screen 112. In this embodiment, a telephone module 240 includes a signal analyzer 244 to analyze an audio signal received at computing device 100. Signal analyzer 244 may analyze signal, which may be configurable, to determine if audio command should be started, if speech synthesis should be triggered, or if a pre-recorded message should be played back.

The term “audio command” herein refers to audio signals comprising commands near computing device 100 directed to an operation associated with an audio command. Signal analyzer 244 receives audio signals sensed by a microphone 113, and may determine to process the operation on computing device 100 or back-end server 150. In response to detection of a particular or relative audio command, computing device 100 may provide an option to activate text-to-speech conversion, speech-to-text conversion, or feature-to-symbol conversion (e.g. display user-definable symbols near an associated feature). An interface 230 may display a virtual button implementing text-to-speech selector 231, speech-to-text selector 232, or feature-to-symbol selector 233 on display screen 112, or may display a message indicating physical buttons for activating these functions. In response to detection of relative or particular signal levels near computing device, computing device 100 may display a number of options. Options may include (FIG. 3): text-to-speech 301, speech-to-text 302, and symbol 303. One of options may be selected using a physical button or a virtual button. Alternatively, activation of text-to-speech conversion, activation of speech-to-text conversion, activation of symbol display may be automatic upon detection of particular or relative audio commands at computing device 100. Computing device 100 may automatically mute microphone 113 and prompt text entry or select a text-message stored in memory 250. In one embodiment, all signals picked up by microphone 113 may be bypassed without being transmitted to backend server 150.

Text-to-speech conversion, speech-to-text conversion, or feature-to-symbol conversion may occur anytime after an audio connection in communication network (e.g., wireless network 120, wired network 130, or VOIP network 140 (FIG. 2)) is established with computing device, or between computing device and backend server 150. Conversion causes no interruption to any established audio connection.

According to this particular embodiment, such a system may comprise a computing platform including a processor 200, memory 250, and/or correlator 260. Correlator 260 may produce correlation functions or operations for signals provided by a receiver (not shown) which may be processed by processor 200, either directly or through memory 250.

Correlator 260 may be implemented in hardware, firmware, software, or any combination. Additionally, memory 250 may store instructions which may be accessible and executable by processor 200. Here, processor 200 in combination with such instructions may perform a variety of the operations previously described, such as, for example, without limitation, correlating a sequence.

Referring to FIG. 3, in response to detection of an audio signal near computing device, display screen 112 may display a number of options for selection. Options may include but are not limited to: text-to-speech 301, speech-to-text 302, and/or symbol 303. One of options may be selected using a physical button or a virtual button.

Referring to FIG. 3, if text-to-speech 301 is selected, a display screen 112 may show “TEXT TO SPEECH” to indicate that text-to-speech conversion had been activated. A physical keyboard or a virtual keyboard may be used to input commands. Display screen 112 may display text entered. As text is input, text-to-speech converter 241 (FIG. 2) may automatically convert text to speech.

Referring to FIG. 3, if speech-to-text 302 is selected, display screen 112 may show “SPEECH TO TEXT” to indicate that speech-to-text conversion had been, or will be activated. Commands may be input via a physical keyboard or a virtual keyboard. Display screen 112 may also display text representing an audio signal. As audio signal is received, a speech-to-text converter 242 (FIG. 2) may automatically convert audio signal into text.

Referring to FIG. 3, if symbol option 303 is selected, display screen 112 may show “SYMBOL” to indicate that feature-to-symbol conversion has been, or will be activated. A physical keyboard or a virtual keyboard may be used to input commands. As audio signal is received, feature-to-symbol converter 243 (FIG. 2) may automatically convert feature into symbol. Display screen 112 may also display text of an audio signal. As audio signal is received, speech-to-text converter 242 (FIG. 2) may automatically convert audio signal into text.

Computing device 100 may transmit converted speech, text, or symbols to back-end server 150, utilizing an audio connection that has been established between computing device and back-end server. Computing device 100 may process converted audio signal, text, or symbols on computing device.

FIG. 4 illustrates an embodiment of computing device's display screen 112 and user-definable symbols associated with particular features of electronic interface. In this embodiment, symbol “1” 401 may represent “back,” a symbol “2” 402 may represent “forward,” and a symbol “3” 403 may represent “refresh.” If a symbol is received by the computing device, an operation associated with that symbol may be performed. Assignment of symbols may be customized to suit various preferences. Voice recognition may allow reception of an audio command (directed to a symbol associated with a feature) that thereby may initiate execution of a feature's underlying operation. For example, if a user desires to scroll right, user might speak audio command representing “B” and associated operation may be performed.

The term “symbol” herein refers to a user-definable representation that acts as an extension or substitute for an electronic interface feature. Examples may include but are not limited to colors, numbers, letters, shapes, transparency, color brightness, color magnitude, or any combinations thereof.

The term “feature” herein refers to an element of an electronic interface. Examples may include but are not limited to hyperlinks, zooming, advancing to new pages, returning to pages previously viewed, scrolling up or down, scrolling left or right, adding to bookmarks or favorites, refreshing page, increasing or decreasing font size or any interface command or any combinations thereof.

In this embodiment, a user may be able to navigate and access web pages using audio commands that direct point and click mechanisms, similar to existing experiences with web pages and email clients without the need to touch the display screen to effect the desired operation. This allows selection of features of interest and access to them in a random-access manner without requiring manual navigation. The initiation of operations by audio commands allows hands-free control, thereby opening up many more situations and locations where hands-free navigation is preferable. Further, display of a particular symbol in a visual interface associated with a particular feature and underlying operations allows for many more and different options to navigate electronic interfaces. For example, the user may be able to issue an audio command to execute a hyperlink, rather than having to physically touch the hyperlink on the display screen. A visual display also means that relevant content, such as symbols associated with hyperlinks, zooming, page changes, etc. and can effect the desired operation by reception of audio commands referencing user-definable symbol thereby operating an associated interface feature.

In this embodiment, an electronic interface may be a central access point for navigation. Options and mechanisms may be presented to provide navigation functionality. A software application may be running on a mobile handset, other computing device, or inside a web browser, among other devices and/or system embodiments.

A system embodiment may include functionality to display current email messages in various formats. A record displayed may include any form of related data not limited to date, time, sender and a selection for the transcribed message text-to-speech as an aid for navigation and identification of a message via audio command. A record may also contain an indicator of status information, such as but not limited to “New”, “Read”, “Print”, and “Respond” that may have particular symbols associated with operations that may be effected via audio command.

A system embodiment may include functionality to display photos or in various formats. A record displayed may include data not limited to date, time, photographer, URL, etc. and a selection for grouping, editing, cropping photos, posting, among other operations, as an aid for navigation and identification of photos via audio command. A record may also contain an indicator of status information, such as but not limited to “New”, “Edit”, “Print”, and “Crop” that may have particular symbols associated with operations that may be effected via audio command.

A system embodiment may include functionality to display articles in various formats. A record displayed includes data not limited to date, time, author, source, URL, etc. and maybe a selection for grouping, editing, copying, posting, among other operations, as an aid for navigation and identification of articles via audio command. A record may also contain an indicator of status information, such as but not limited to “New”, “Edit”, “Print”, or “Copy” that may have particular symbols associated with operations that could be effected via audio command.

A system embodiment may include functionality to display electronic pages from social media sites (including but not limited to Flicker, Facebook, LinkedIn, Twitter, etc.) in various formats. A record displayed includes data not limited to date, time, user, URL, etc. and a selection for grouping, “liking”, “friending”, “sharing”, “tweeting”, and “re-tweeting”, among other operations, as an aid for navigation and identification of other users via audio command. A record may also contain an indicator of status information, such as but not limited to “New”, “Like”, “Print”, and “Friend” that may have particular symbols associated with operations that could be effected via audio command.

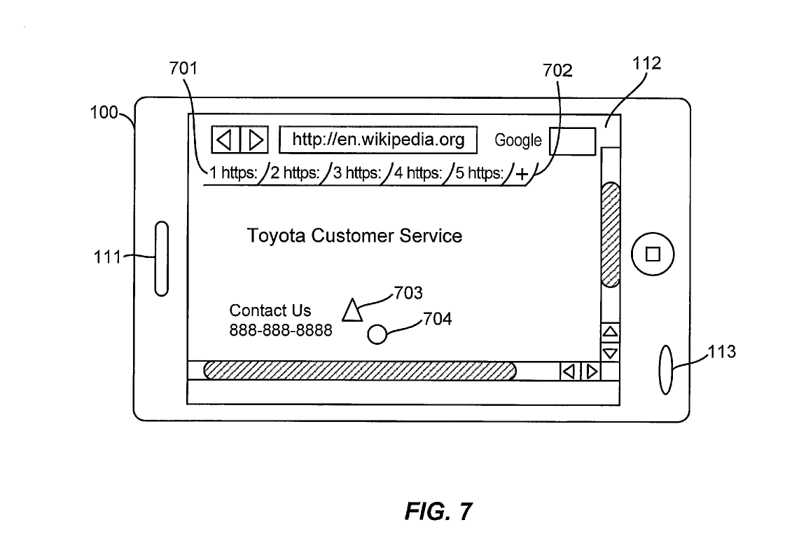

A system embodiment may include functionality to display pages in various formats resulting from tunneling further into an electronic interface. A record displayed includes data including but not limited to date, time, author, source, URL, etc. and maybe a selection for executing hyperlinks, creating new tabs, copying, advancing to next page, going back to previous page, among other operations, as an aid for navigation and identification of the pages via audio command. A record may also contain an indicator of status information, such as but not limited to “New”, “Add to Favorites”, “Print”, “Download”, and “Read” that may have particular symbols associated with operations that could be effected via audio command. See FIG. 7.

A system embodiment may include functionality to search through electronic interfaces. Selections may be entered manually or through audio commands, search criteria and search results may be returned matching specified criteria. Search fields including but not limited to name, date and electronic interface type may also be searched. Search results may be sorted via predefined criteria. audio commands may specify which criteria to sort by and a system embodiment may reorder the results based on criteria or a predefined sort order.

One embodiment may allow sorting search results based at least in part on when an electronic interface was used. Time of viewing may be selected from a list of possible criteria and a system embodiment may reorder documents according to when they were viewed, earliest to latest, or vice versa.

If an individual electronic document has been selected, a system embodiment may display the interface in its own visual representation. This visual representation may include details on the host and the URL, as well as actual content of electronic interface. Visual representation may display text of interface as well as user-definable symbols associated with particular features within interface. Visual representation may also provide controls which help manage navigation manually or via audio command. Navigation may be managed by turning audio-commanded navigation on or off, or otherwise using the navigation mechanisms to navigate around content of a message. Issuing audio commands may navigate to symbols associated with electronic interface features that may be further associated with operations to perform such actions as but not limited to scrolling up or down, executing a hyperlink, initiating an email or instant message or converting voice input to text as well as delivering mail or messages to specific recipients, tunneling into web pages, zooming in or out, opening a new tab, advancing to a next page, returning to a previous page, adding a web page to favorites, bookmarking a web page, logging in to an email or social media account, or navigating an email or social media account. Navigation may be accomplished via audio command and/or manually.

A system embodiment creates an alternate representation of the electronic interface content as text. This means that a message may be in at least but not limited to two formats including text or audio. Various formats may cross-index and synchronize to one another.

Any word may be selected in text or a system embodiment may automatically move to a corresponding point in audio signal and begin playback from point. Any point in the audio playback may be selected and a system embodiment may automatically move to a corresponding point in the text. This may be accomplished via a slider-bar or buttons on interface or on handset or other similar device. audio commands may be issued to effect a similar system embodiment. Any word or phrase may be selected in text or a system embodiment may play just a snippet of audio corresponding to that word or phrase.

A system embodiment recognizes electronic interface features and may automatically associate and/or assign user-definable symbols to particular features. Selection of symbol initiates execution of an operation associated with feature. Likewise, this concept may be extended to initiate other operations.

A system embodiment may recognize identifiers, such as features, in content of electronic interface and automatically create or assign a symbol from identification. Identifiers may be looked up or be included in displayed interface if generated on back-end. Selection of symbol initiates execution of operation.

A system embodiment recognizes features in an interface and provides option for adding features in interface to on-device feature/symbol preferences for future recognition of previously non-definable features. Undesired feature or symbol associations may be corrected and change may be reflected in interfaces viewed and navigated in the future.

A system embodiment may include notifications that a new message, voice-mail, email, or instant message, has been left while a service provider was not being used. Inbox may be bypassed by action. Notification display may be navigated to such as, but not limited to new voice-mail, email, or instant message by taking any other action on notification display.

One embodiment of this mechanism may provide a link along with notification of a new voice-mail or email. The link may be clicked or a command may be received to display or play voice-mail, email, or instant message for voice-mail, email, or instant message. The nature of the link may be determined by device's interface.

One mechanism to check for new voice-mails, emails, or instant messages is to periodically query a system embodiment. Under this mechanism, a handset or other similar device may initiate a connection to a system embodiment, submit identifying information or receive the availability and number of new messages. Regardless of whether or not new messages have been received, the handset or other similar device may wait a predetermined amount of time and perform a query process again. This may happen indefinitely.

Computing device may be set to query a main message system embodiment based on certain trigger events. Examples of such events include but are not limited to: missed phone call, entry into coverage area from an area with no coverage, power-on of the phone, etc.

If user receives notification of missed message, handset or other similar device may wait an amount of time to perform a query to check for new messages. It may be desirable to wait an amount of time to allow a caller to record a message and to allow for processing time of a recorded message on a system embodiment. If a predetermined amount of time has been met or exceeded, handset or other similar device may perform the query to check for new messages.

A computing device may not establish a communication network connection if computing device is out of a coverage service area. Furthermore, a query may not be completed without service. However, messages may still be left at a centralized system embodiment. As such, if handset or other similar device enters into service coverage area, a message may be waiting. The handset or other similar device may thus initiate a query call after entering a service coverage area.

A computing device may contain personal information. As such, care may be taken by a system embodiment so that device is protected and unauthorized access is not imprudently granted.

One method used by a system embodiment to authenticate is via an audio signal representing a password. A system embodiment may identify a user based at least in part on an audio signal representing a password, a pass phrase, and may match that identification to a previously-stored identification on a system embodiment. If there is a match, access may be granted to contents of device on a system embodiment. If an audio signal representing a password or pass phrase does not match, access may be denied or an alert may be reported.

A system embodiment makes use of speech recognition, especially in the area of receiving an audio signal. A system embodiment may contain various novel applications of speech recognition, as well as methods to enhance accuracy of speech recognition.

A system embodiment may represent a novel delivery of speech recognition services as a network-centric service. Speech recognition functionality may reside on network and make its functionality accessible through interfaces into and out of a system embodiment. A system embodiment may receive audio input or may determine a format of audio signal and identify a correct handler for a determined format. A system embodiment may also determine a speech to text engine to use to convert audio signal to text, as determined via a system embodiment configuration, and invoke engine to convert audio signal to text. A system embodiment may return the converted text to a calling system embodiment. Speech recognition network service may operate without training, but if training or samples are available, it may make use of them to enhance accuracy.

As a method to improve the accuracy of speech recognition, a system embodiment may maintain a speech profile for individuals whose speech is being transcribed. Electronic audio signals made by individuals on a system embodiment may be stored and added to their profile to build a set of speech samples for individual. Set of speech samples may be later used to improve accuracy and/or efficiency of speech recognition engine.

A system embodiment may maintain speech profiles not only for current users of a system embodiment, but also for other individuals. A system embodiment may use these profiles of other individuals to improve accuracy of speech recognition in a similar manner that it may use profiles of the current system embodiment users.

A system embodiment may be able to determine identity of a caller through characteristics of caller's voice. Identification may be used in improving speech recognition, such as automatically retrieving a voice profile for user.

A system embodiment may be set up so as to assume that a speaker on a cell phone or similar device is the only one that may use device. By this setting, messages arriving from phone are associated with computing device user's speech profile.

A system embodiment may include features that enable the use of training to improve accuracy of speech recognition. Training may be conducted by any individuals involved, or by external parties.

A system embodiment may allow training by a sender. Sender may specify correct transcription to a captured audio signal.

One possible embodiment comprises a system that enables a sender to train system based at least in part on an audio signal. For example, sender may speak a message, wait for system embodiment to transcribe it, and be presented with transcription results. Sender may correct any mis-transcribed words. A system embodiment may record corrections and create an updated model of sender's speech for use in later transcriptions from user.

A system embodiment may allow training by a recipient. Recipient may specify the correct transcription to captured audio signal. One possible embodiment is one that enables a recipient to train a system embodiment on an electronic audio signal from a particular sender. For example, sender may speak a message and have it delivered to a user, as with the normal operation of a system embodiment. User may receive message, but may have an option to correct any mis-transcribed words. A system embodiment may record corrections and create an updated model of sender's speech for use in later transcriptions from sender.

A system embodiment may allow training via manual correction. Transcribed messages from a particular caller may be routed for manual transcription or correction. Changes may be recorded by a system embodiment and used to enhance accuracy of speech recognition on messages from sender. A system training embodiment may use manual transcriptions until adding additional transcriptions into a system embodiment may negligibly or otherwise not significantly improve transcription quality for a speaker, such as through an improvement measure.

One possible embodiment comprises a system that enables routing of messages to users who may transcribe it or make corrections in a machine transcription. Sender may speak a message and have it delivered to user. User may receive message. Message and transcription may also be sent to a call center where message transcription may be corrected. A system embodiment may record corrections and may add them to a model of sender's voice. A system embodiment may use model to enhance accuracy of other messages from same sender.

Another possible embodiment may be a system that enables routing of messages to people who may transcribe them manually. Message may also be sent to a call center where employees may transcribe message manually or where it may be done with a combination of automatic and/or manual approaches. This may be done by having employees repeat a message into another speech recognition system embodiment highly trained on the employee's voice and/or through a microphone. Transcriptions and original audio may be added to sender's model to enhance accuracy of later messages from sender.

A system embodiment may also offer an interface linked to a handset or other similar device for manual correction. An audio signal may be processed and sent to a back-end system, or the electrical audio signal may be processed on a back-end system via a cellular connection.

A back-end system may perform speech recognition on an electrical audio signal and display a transcribed message on a web-based interface. If transcriber indicates more than one possibility through special marking, a list of alternate transcriptions may be displayed. Transcription may be corrected by picking an alternate transcription from a list. Transcription may be corrected by manually editing a single word or phrase.

A system embodiment may allow training via a web-based interface and/or a cellular connection. Traditional systems enable training via a computer application and a microphone. A system embodiment may provide a mechanism where a web-based interface is used to display a known script to the user. An audio signal may be captured via a cellular connection on a handset or similar device, and transcribed with an original script as a known comparison sample. This mechanism may not require the use of any computer microphones or applications, other than a software application running on a computer.

One possible embodiment of such a system comprises one that enables training via a web interface. A web interface may display a known script. A specified number may be dialed on a handset or other similar device and a user may speak known script. User may indicate completion of a section of text via codes, such as, but not limited to dialing a number to indicate end of a paragraph. This allows for an improved training experience using dynamic text. An audio signal may be recorded on a back-end system embodiment. An electrical audio signal may be transcribed, using known script as a comparison sample for transcriber to use in determining correct transcription. Since a system embodiment may be able to recognize who is recording the message, several improvements may be made to sound quality and speech transcription. For example, an audio signal recorded on a handset or similar device may be recorded at a higher quality than sound recorded via a cellular connection. Higher quality electrical audio signal may result in higher quality transcription.

A system embodiment may also offer use of all-manual transcription or a mix of automatic and manual approaches. Users may be able to specify that they wish to receive only manually-transcribed messages or a mix. However, instead of transcribing message via automated system embodiment, audio is sent to a call center where message is transcribed manually or via a mix of approaches. If transcription is complete, message may be delivered to a user through a similar approach as other messages.

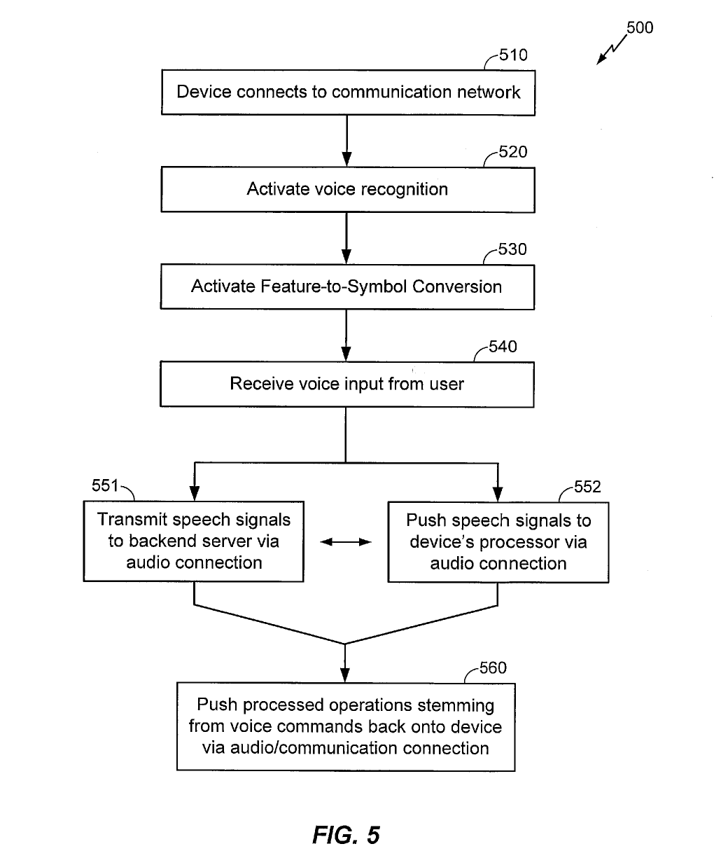

FIG. 5 is a flow diagram illustrating an embodiment of a method 500 for generating audio signals at a computing device 100, and transmitting electrical audio signals to a backend server 150 or to device's processor 200. Method 500 may be performed by computing device that comprises hardware, firmware, software, or any combination thereof. One embodiment of method 500 begins if a communication device requests a communication network connection 510. In one embodiment, the computing device may activate or recommend activation of voice recognition 520. After activation of feature-to-symbol conversion 530, a communication device may receive input from a user 540. Computing device may transmit electrical audio signal to back-end server 150 via established audio connection 551. Computing device may transmit electrical audio signal to device's processor 200 via an established audio connection 552. Back-end server 150 and device's processor 200 may execute operations including but not limited to singularly, in tandem, dependently, independently, or any combination thereof. Once electrical audio signals have been processed on back-end server 150 or device's processor 200, processed operations stemming from audio commands represented by electronic audio signal may be pushed back onto the device via audio connection 660.

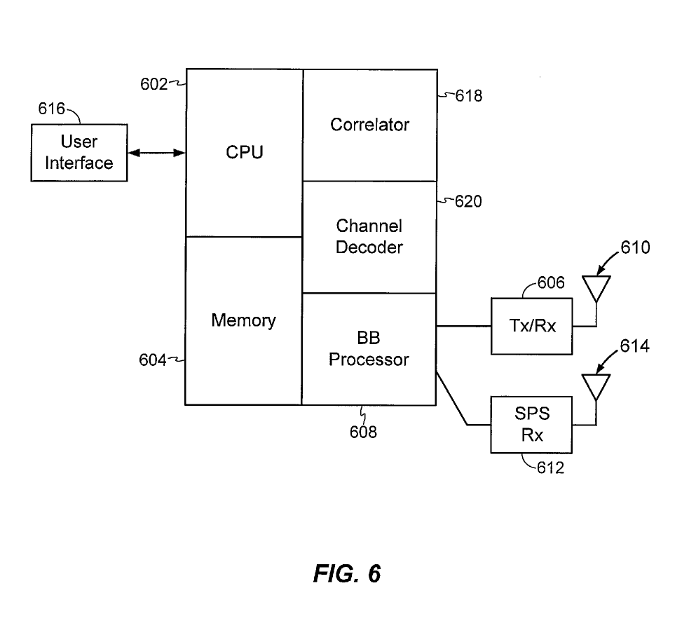

Turning to FIG. 6, radio transceiver 606 may modulate a radio frequency carrier signal with baseband information, such as voice or data, or demodulate a modulated radio frequency carrier signal to obtain baseband information. Antenna 610 may transmit modulated radio frequency carrier or receive modulated RF carrier, such as via a wireless communications link.

Baseband processor 608 may provide baseband information from central processing unit (CPU) 602 to transceiver 606 for transmission over a wireless communications link. Here, CPU 602 may obtain such baseband information from an input device within user interface 616. Baseband processor 608 may also provide baseband information from transceiver 606 to CPU 602 for transmission through an output device within user interface 616. User interface 616 may comprise a plurality of devices for inputting or outputting user information, such as voice or data. Such devices may include, but are not limited to, for example, a keyboard, a display screen, a microphone, or a speaker.

Here, a receiver 612 may receive or demodulate transmissions, or provide demodulated information to correlator 618. Correlator 618 may apply correlation functions from information provided by receiver 612. For a given pseudo-random noise sequence, for example, correlator 618 may produce a correlation function which may, for example, be applied in accordance with defined coherent and non-coherent integration parameters. Correlator 618 may also apply pilot-related correlation functions from information relating to pilot signals provided by transceiver 606. Channel decoder 620 may decode channel symbols received from baseband processor 608 into underlying source bits. In one example in which channel symbols comprise convolutionally encoded symbols, such a channel decoder may comprise a Viterbi decoder. In a second example, in which channel symbols comprise serial or parallel concatenations of convolutional codes, channel decoder 620 may comprise a turbo decoder.

Memory 604 may store instructions which are executable to perform one or more of processes or implementations, which have been described or suggested previously, for example. CPU 602 may access and execute such instructions. Through execution of instructions, CPU 602 may direct correlator 618 to perform a variety of signal processing related tasks. However, these are merely examples of tasks that may be performed by a CPU in a particular aspect and claimed subject matter in not limited in these respects. It should be further understood that these are merely examples of systems for estimating a position location and claimed subject matter is not limited in these respects.

Referring to FIG. 7, a device's display screen 112 may display multiple tabs as a result of tunneling into a website via execution of hyperlinks on successive pages. “Tab 1” 701 may represent a tab with a URL. If, for instance, a user desires to view the web page associated with “Tab 1”, a user may issue an audio command “1” which may result in that tab's corresponding electronic interface to be displayed. Opening a new window may be automatic; for example, if user initiates execution of hyperlink 703 by issuing audio command “triangle”, a window may appear and may display the relevant electronic interface associated with the audio command. Electronic interface linked to a hyperlink may include but is not limited to a web page, an email, telephone number, or any combination thereof. The opening of a new window may not be automatic; for example, if user wants to add a new window but is not prepared to command a URL, a user may issue a “plus” 702 command whereby a window with a blank browser may appear on the device's display 112. Additionally, if a symbol “circle” is associated with a command to initiate an audio connection with a number, audio command “circle” may be commanded to initiate an audio connection with number.

In general, computing device (e.g., the telephone module 240 of FIG. 2) may be configured or programmed by user to support one or more of the above-described features.

In another embodiment, an ordered plurality of symbols or an audio signal may comprise a list of commands. List of commands may be transferred to another computing device where list of commands may be executed. This allows automation of a scripted set of commands for an electronic interface. For example, a series of commands which navigate a series of web pages may be issued on a first computing device. The series of commands may be recorded and transferred to a second computing device. If the commands are executed on the second computing device, the second computing device may perform substantially the same commands resulting in substantially the same series of web pages. For example, if language restrictions make it difficult for a user to experience a series of web pages, a list of commands may be provided which cause the computing device to navigate the web pages and provide substantially the same web experience without user intervention.

In another embodiment, a plurality of symbols or an audio signal may comprise a list of commands. List of symbols or commands may be recorded resulting in historical documentation of commands for computing device. This allows for storing history without referencing long URL strings resulting in less required space to record session information.

Audio signal as used herein may include any oscillation of pressure transmitted through a solid, liquid, gas, or mixed medium. Audio signal as used is meant to encompass all frequencies and magnitudes and does not necessarily need to be in the range capable of being sensed by an audio device.

Electronic audio signal as used herein may include any analog derivative, digital derivative, analog representation, or digital representation of an audio signal. Electronic audio signals may be directly synthesized, or originate at any device capable of sensing audio signals, including, but not limited to a microphone, phonograph, or tape head.

Likewise, the terms, “and,” “and/or,” and “or” as used herein may include a variety of meanings that will, again, depend at least in part upon the context in which these terms are used. Typically, “and/or”, as well as “or” if used to associate a list, such as A, B or C, is intended to mean A, B, or C, here used in the exclusive sense, as well as A, B and C. In addition, the term “one or more” as used herein may be used to describe any feature, structure, or characteristic in the singular or may be used to describe some combination of features, structures or characteristics.

Some portions of the preceding detailed description which were presented in terms of algorithms or symbolic representations of operations on data bits or binary digital signals stored within a computing system memory, such as a computer memory. These algorithmic descriptions or representations encompass techniques used by those of ordinary skill in the data processing or similar arts to convey the substance of their work to others skilled in the art. An algorithm is here, and generally, considered to be a self-consistent sequence of operations and/or similar processing leading to a desired result. Operations and/or processing involve physical manipulations of physical quantities. Typically, although not necessarily, these quantities may take the form of electrical or magnetic signals capable of being stored, transferred, combined, compared or otherwise manipulated. It has proven convenient, at times, principally for reasons of common usage, to refer to these signals as bits, data, values, elements, symbols, characters, terms, numbers, numerals or the like. It should be understood, however, that all of these or similar terms are to be associated with the appropriate physical quantities and are intended to merely be convenient labels. Unless specifically stated otherwise, as apparent from the following discussion, it is appreciated that throughout this specification, discussions utilizing terms such as “processing”, “computing”, “calculating”, “determining” or the like refer to the actions or processes of a computing platform, such as a computer or a similar electronic computing device, that manipulates or transforms data represented as physical electronic or magnetic quantities, or other physical quantities, within the computing platform's memories, registers, or other information storage, transmission, or display devices.

The term “computing device” herein broadly refers to various real-time, handheld communication devices, e.g., landline telephone system (POTS) end stations, voice-over-IP end stations, cellular handsets, smart phones, etc. A computing device may be capable of sending or receiving signals, such as via a wired or a wireless network. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A computing device may vary in terms of capabilities or features. Claimed subject matter is intended to cover a wide range of potential variations. For example, a computing device may include a numeric keypad or a display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, or a display with a high degree of functionality, such as a touch-sensitive color 2D or 3D display, for example.

A computing device may include or may execute a variety of operating systems, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute an application to communicate content, such as, for example, textual content, multimedia content, or the like. A computing device may also include or execute an application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

It should be understood that for ease of description in the present disclosure that computing device may be embodied as and described in terms of a phone. However, it should further be understood that this description should in no way be construed that the claimed subject matter is limited to this embodiment and instead may be embodied as a variety of computing devices as described above.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). Computing device may also have a subscriber identity module (SIM) card, which, for example, may comprise a detachable smart card that contains subscription information of a user, and may also contain a contact list of the user. A user may own the computing device or may otherwise be its primary user. A computing device may be assigned a unique address by a wireless or wired telephony network operator, or an Internet Service Provider (ISP). For example, a unique address may comprise a domestic or international telephone number, an Internet Protocol (IP) address, or other unique identifiers. In other embodiments, a communication network may be embodied as a wired network, wireless network, or combination therein.

Computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining two or more features of the foregoing devices, or the like.

Servers may vary widely in configuration or capabilities, but generally a server may include one or more central processing units and memory. A server may also include one or more mass storage devices, one or more power supplies one or more wired or wireless network interfaces, one or more input/output interfaces, or one or more operating system, such as Windows Server, Mac OS X, Unix, Linux, FreeBSD, or the like.

A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wilds, financial sites, government sites, etc.

A content server may further provide a variety of services that include, but are not limited to, web services, third-party services, audio services, video services, email services, instant messaging (IM) services, SMS services, MMS services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may be made available so that interoperability is present. For example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communications links or channels known to those skilled in the art or later developed. Furthermore, remote computers or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Therefore, wireless communication or location determination techniques, such as, for example, the embodiments previously described, may be used for a host of various wireless communication networks. Without limitation, these may include Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network may implement one or more radio access technologies (RATs) such as cdma2000, Wideband-CDMA (W-CDMA), or Universal Terrestrial Radio Access (UTRA), to name just a few radio technologies. Here, cdma2000 may include technologies implemented according to IS-95, IS-2000, or IS-856 standards or specifications. UTRA may include Wideband-CDMA (W-CDMA) or Low Chip Rate (LCR). A TDMA network may implement a radio technology such as Global System for Mobile Communications (GSM). An OFDMA network may implement a radio technology such as Evolved UTRA (E-UTRA), IEEE 802.11, IEEE 802.16 (also referred to as the WiMAX specification), IEEE 802.20, Flash-OFDM®, etc. UTRA, E-UTRA, and GSM are part of Universal Mobile Telecommunication System (UMTS). Long Term Evolution (also referred to as LTE or the LTE specification) is a release of UMTS that may use E-UTRA. UTRA, E-UTRA, GSM, UMTS and LTE are described in documents that may be obtained from the 3rd Generation Partnership Project (3GPP). Cdma2000 is described in documents that may be obtained from the 3rd Generation Partnership Project 2 (3GPP2). 3GPP and 3GPP2 documents are, of course, publicly available.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network, for example. A signal packet communicated via the Internet may be routed via a path of gateways, servers, etc. that may route the signal packet in accordance with a target address and availability of a network path to the target address.

A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

A peer-to-peer (or P2P) network may employ computing power or bandwidth of network participants rather than being concentrated in dedicated devices, such as dedicated servers. A P2P network may typically be used for coupling nodes via an ad hoc arrangement or configuration. A peer-to-peer network may employ nodes capable of operating as a “client” and/or a “server.”

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

In the following description, various aspects of claimed subject matter have been described. For purposes of explanation, specific numbers, systems and/or configurations were set forth to provide a thorough understanding of the claimed subject matter.

However, it should be apparent to one skilled in the relevant art having benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

What is claimed is:

1. A method of displaying an electronic interface on a display of a computing device, the method comprising:
(a) displaying particular features of said electronic interface respectively associated with particular corresponding symbols;
(b) receiving audio commands referencing one or more of said particular corresponding symbols for one or more operations to be performed with respect to one or more of said particular features;
(c) processing said audio commands so that said audio commands are executable by said device; and
(d) performing said one or more operations indicated by said audio commands.

2. The method of claim 1, wherein said electronic interface includes one or more web pages.

3. The method of claim 1, wherein said computing device includes a handheld device.

4. The method of claim 3, wherein said handheld device includes a handheld-sized display.

5. The method of claim 3, wherein said handheld device includes a mobile phone.

6. The method of claim 1, wherein said symbols include any uniquely identifiable designation.

7. The method of claim 6, wherein said any uniquely identifiable designation includes any uniquely visually identifiable designation.

8. The method of claim 6, wherein said any uniquely identifiable designation includes any uniquely audibly identifiable designation.

9. The method of claim 1, wherein said one or more operations includes: executing a hyperlink.

10. The method of claim 1, wherein said one or more operations includes: zooming said display.

11. The method of claim 1, wherein said one or more operations includes: returning to a page previously displayed.

12. The method of claim 1, wherein said one or more operations includes: opening a tab.

13. An apparatus comprising:
a computing device, said computing device adapted to process one or more audio commands for one or more operations to be performed by said device with respect to a displayed electronic interface.

14. The apparatus of claim 13, wherein said computing device is further adapted to initiate voice recognition in response to an audio command.

15. The apparatus of claim 13, wherein said computing device is capable of performing said one or more operations to execute a hyperlink as a result of processing said one or more audio commands.

16. The apparatus of claim 13, wherein said computing device is capable of performing said one or more operations to zoom a portion of said displayed electronic interface as a result of processing said one or more audio commands.

17. The apparatus of claim 13, wherein said computing device is further capable of processing one or more of said audio commands that reference one or more particular symbols corresponding to one or more particular features of said displayed electronic interface.

18. The apparatus of claim 17, wherein said computing device is further capable of processing one or more of said audio commands that reference one or more particular symbols, said particular symbols comprising at least one of colors, numbers, letters, shapes or combinations thereof.

19. The apparatus of claim 17, wherein said computing device is further capable of processing one or more of said audio commands that reference one or more particular features, said particular features comprising a back button, a home button, a hyperlink, zooming, scrolling, opening a tab, or any combinations thereof.

20. An article comprising:
a storage medium having stored thereon instructions executable by a computing device to process one or more audio commands for one or more operations to be performed by said device with respect to a displayed electronic interface.

21. The article of claim 20, wherein said instructions are further executable by said computing device to: initiate voice recognition in response to an audio command.

22. The article of claim 21, wherein said instructions are further executable by said computing device to processing said one or more audio commands includes applying voice recognition techniques to said one or more audio commands.

23. The article of claim 20, wherein said instructions are further executable by said computing device to execute said one or more operations in response to said one or more audio commands.

24. The article of claim 20, wherein said instructions are further executable by said computing device to display said electronic interface after performing said one or more audio commands.

25. The article of claim 20, wherein said instructions are further executable by said computing device to convert analog electronic signals to binary digital signals capable of being further processed by said device, wherein a microphone is operable to convert said audio commands to said analog electronic signals.

26. The article of claim 20, wherein said instructions are further executable by said computing device to process one or more of said audio commands that reference one or more particular symbols corresponding to one or more particular features of said displayed electronic interface.

27. A method of navigating one or more electronic interfaces displayed on a computing device, said method comprising:
(a) displaying particular features of said one or more electronic interfaces respectively associated with particular corresponding symbols;
(b) receiving audio commands referencing one or more of said particular corresponding symbols for one or more operations to be performed with respect to said one or more electronic interfaces;
(c) processing said audio commands so that said audio commands are executable by said device; and
(d) performing said one or more operations indicated by said audio commands with respect to said one or more electronic pages.
